(19) United States
(12) Patent Application Publication
(10) Pub. No.: US 2018/0012332 A1
(43) Pub. Date: Jan. 11, 2018

(54) METHOD FOR PREVENTING BURN-IN CONDITIONS ON A DISPLAY OF AN ELECTRONIC DEVICE

(71) Applicant: LENOVO (SINGAPORE) PTE. LTD., SINGAPORE (SG)

(72) Inventors: NOZOMI ISHIHARA, GUNMA-KEN (JP); KYOHEI SUGIYAMA, KANAGAWA-KEN (JP); YUICHI SHIGEMATSU, KANAGAWA-KEN (JP)

(21) Appl. No.: 15/333,316

(22) Filed: Oct. 25, 2016

(30) Foreign Application Priority Data
Jul. 8, 2016 (JP) 2016-135966

(51) Int. Cl. G06T 3/20; G06T 11/00; G09G 5/38

(52) U.S. Cl. CPC G06T 3/20; G09G 5/38; G06T 11/001; G09G 2320/0233; G06T 2210/62; G09G 3/3208; G09G 2320/0257; G09G 2320/046

(57) ABSTRACT

A method for preventing burn-in conditions on a display of an electronic device is disclosed. The electronic device acquires a position of, for example, a task bar being displayed on an OELD screen, extracts a color of a pixel located adjacent to the task bar, and generates an overlay window of a color based on the extracted color. The color of the overlay window is translucent and continuously changes from the extracted color to black with an increase of the distance from the pixel located adjacent to the task bar. The task bar is displayed on the OELD screen with the overlay window overlaying the task bar.

### PRIORITY CLAIM

The present application claims benefit of priority under 35 U.S.C. §§120, 365 to the previously filed Japanese Patent Application No. JP2016-135966 with a priority date of Jul. 8, 2016, which is incorporated by reference herein.

### TECHNICAL FIELD

The present invention relates to electronic devices in general, and in particular to a method for preventing burn-in conditions on a display of an electronic device.

### BACKGROUND

Light-emitting methods of displays are generally classified into a non-self-emission type typified by a liquid crystal display (LCD) and a self-emission type typified by a plasma display panel (PDP) or an organic electro luminescence (EL) display (OELD). Some displays of the self-emission type tend to show luminance degradation, which is caused by light-emitting devices constituting pixels degrade with light-emission time so that the luminance decreases from the start of use irrespective of the supply of the same energy (pixel value).

Regarding the luminance of a light-emitting device constituting a pixel degrades as compared to those of light-emitting devices constituting its adjacent pixels, when a pixel value indicating the same color is set for these pixels, the presence of the degraded light-emitting device is visually recognized by a human eye, the condition is called burn-in. For example, there arises a difference in luminance degradation between a pixel that has continuously displayed white and a pixel that has continuously displayed black. Thus, in a region showing such a difference in luminance degradation, a coloring difference between a region showing small luminance degradation and a region showing strong luminance degradation is visually recognized as burn-in.

In an organic EL, luminance degradation proceeds more quickly than displays of other light-emission types, and thus, burn-in easily occurs. For example, burn-in easily occurs especially in a region of an image that is continuously displayed without substantial change of the position thereof, such as a task bar or an icon displayed on a desktop. For this reason, an image such as a task bar can be visually recognized as an after-image in some cases when an image or a moving image is displayed in full screen.

### SUMMARY

In accordance with a first embodiment of the present disclosure, an electronic device includes a display for displaying images, a position acquisition unit for acquiring a position of a fixed image being displayed on the display, a color extraction unit for extracting a color of a pixel located adjacent to the fixed image, a mask generation unit for generating a mask of a color based on the color of the pixel located adjacent to the fixed image, and an image display control unit for displaying the fixed image on the display with the mask overlaid on the fixed image.

In accordance with a second embodiment of the present disclosure, an electronic device includes a display for displaying images, a position acquisition unit for acquiring a position of a fixed image being displayed on the display, and an image display control unit for repeatedly moving the fixed image by a predetermined movement amount at each time in at least one of a longitudinal direction or a lateral direction at a predetermined time interval.

All features and advantages of the present disclosure will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of a laptop PC according to an embodiment of the present invention;

FIG. 2 is a block diagram of the laptop PC from FIG. 1;

FIG. 3 is a diagram illustrating a task bar displayed on an OELD according to an embodiment of the present invention;

FIG. 4 is a diagram illustrating an example in which a translucent window is overlaid on the task bar according to an embodiment of the present invention;

FIG. 5 is a block diagram concerning a burn-in preventing function according to an embodiment of the present invention;

FIG. 6 is a flowchart showing a method for preventing burn-in conditions on a display, according to an embodiment of the present invention;

FIG. 7 shows a cell according to an embodiment of the present invention; and

FIGS. 8A-8D are views illustrating minute movement of the task bar according to an embodiment of the present invention.

### DETAILED DESCRIPTION

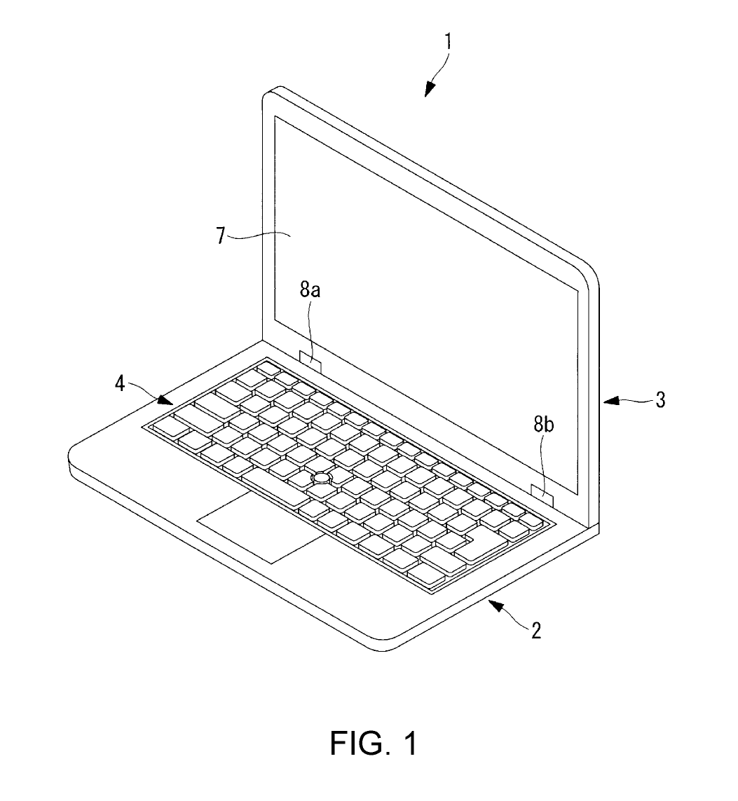

FIG. 1 is a perspective view of a laptop PC 1 according to one embodiment. As illustrated in FIG. 1, the laptop PC 1 includes a main body chassis 2 and a display chassis 3 each of which is substantially cuboid. The main body chassis 2 includes an input section 4. The input section 4 is a user interface for enabling a user to perform an input operation, and includes, for example, a keyboard constituted by keys for accepting inputs such as characters and commands, and a touch pad, a mouse, or a trackpoint for shifting a cursor on a screen or selecting a menu. The input section 4 may be a software keyboard.

The display chassis 3 includes a touch panel display 7 for displaying images. The touch panel display 7 converts input display data to a video signal to display information items on a display screen in accordance with the converted video signal, and detects a manipulation performed with an indicator such as a finger of a user or a touch pen.

The main body chassis 2 and the display chassis 3 are coupled together by a pair of left and light connecting parts 8a and 8b. The connecting parts 8a and 8b are hinges, and support the main body chassis 2 and the display chassis 3 in such a manner that the main body chassis 2 and the display chassis 3 can be freely opened or closed.

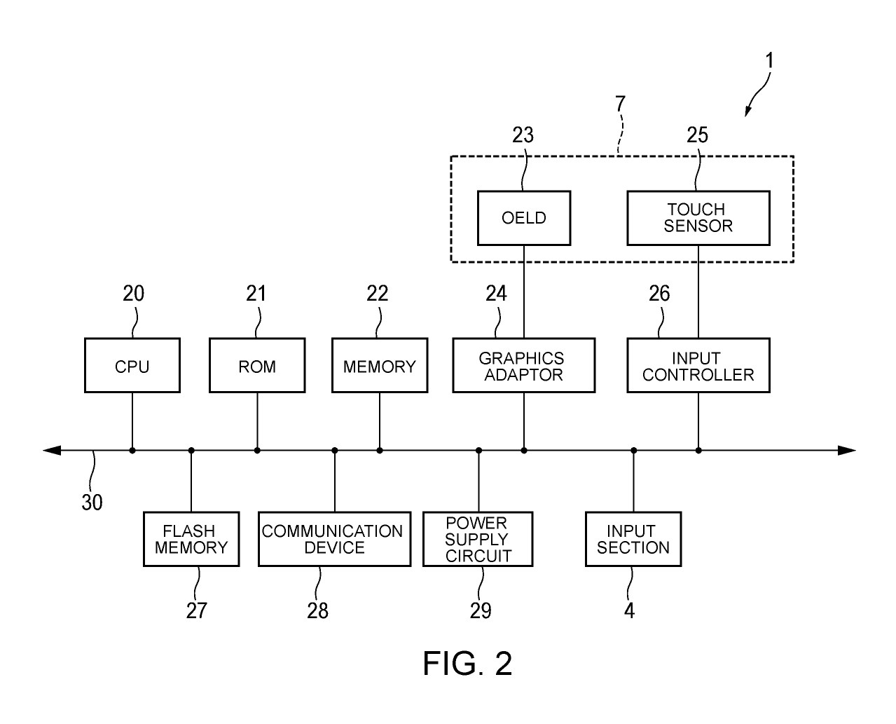

FIG. 2 is a block diagram of the laptop PC 1. As shown, the laptop PC 1 includes a central processing unit (CPU) 20, a read only memory (ROM) 21, a memory 22, an OELD 23, a graphics adaptor 24, a touch sensor 25, an input controller 26, a flash memory 27, a communication device 28, and a power supply circuit 29. These components are connected directly or indirectly through a bus 30. The touch panel display 7 includes the OELD 23 and the touch sensor 25.

The CPU 20 controls the entire laptop PC 1 with an operating system (OS) stored in the flash memory 27, and has the function of executing a process in accordance with a manipulation by a user through, for example, the input section 4 and the touch panel display 7, based on programs stored in the flash memory 27.

The ROM 21 stores a basic input/output system (BIOS) and various types of data, for example. The memory 22 is a cache memory or a random access memory (RAM), and is a writable memory that can be used as a work area for reading of a program to be executed by the CPU 20 and for writing of data to be processed with an execution program.

The OELD 23 displays a video signal from the graphics adaptor 24 as an image in accordance with control of the CPU 20. In accordance with the control of the CPU 20, the graphics adaptor 24 converts display information to a video signal and outputs the converted video signal to the OELD 23.

The touch sensor 25 detects a touch position of a finger of a user or a touch pen on the OELD 23, and outputs the detected touch position to the input controller 26. Then, the touch sensor 25 is used for performing an input operation by selecting a screen object such as a menu, an icon, a button, or a keyboards displayed on the screen of the OELD 23, and a screen operation such as a text input operation and a screen operation such as scroll or swipe is performed with the finger of the user or the touch pen, for example.

The input controller 26 performs processes by execution of programs stored in, for example, the ROM 21 by a processor, and controls an operation of the touch sensor 25.

The flash memory 27 has the function of storing, for example, an OS for controlling the entire laptop PC 1, drivers for hardware operation of, for example, peripheral equipment, an application for a specific job, various types of data, and files. The laptop PC 1 may have another storage means such as hard disk drive (HDD) instead of the flash memory 27.

The communication device 28 performs communication with other devices. The power supply circuit 29 includes an AC adaptor, an intelligent battery, a charger for charging the intelligent battery, and a DC to DC converter, for example, and supplies power to the devices under the control of the CPU 20.

As mentioned above, a burn-in condition can easily occurred in a region of a fixed image that is a display object fixedly displayed without a substantial change of the position on the screen of the OELD 23, such as a task bar or an icon displayed on a desktop.

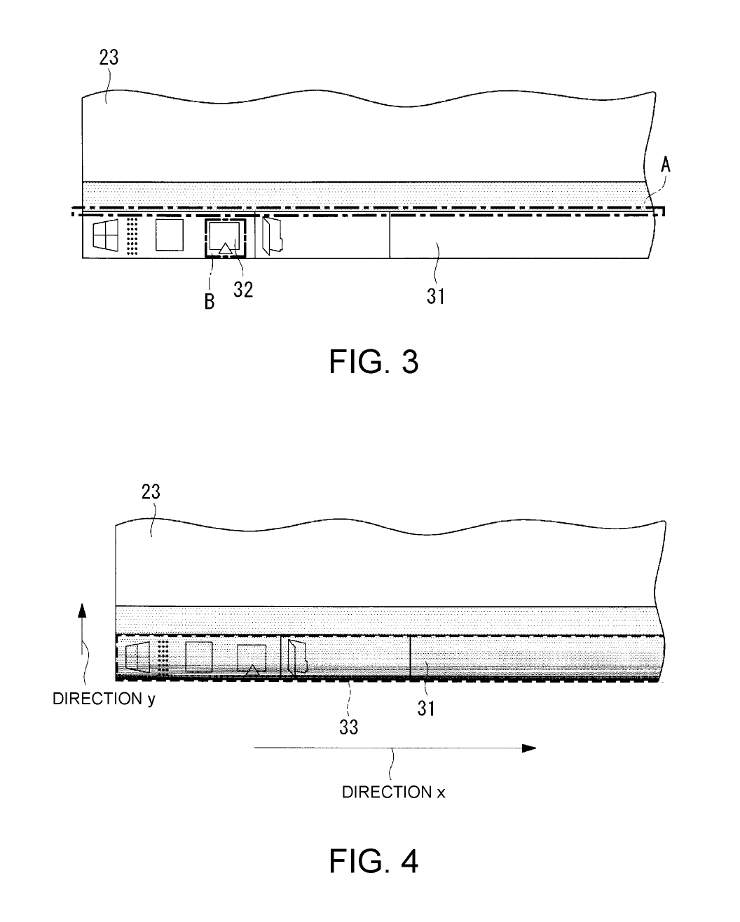

FIG. 3 illustrates a region where a difference in luminance degradation occurs due to burn-in of the task bar 31. As illustrated in FIG. 3, in a case where the task bar 31 is located below the desktop, a difference in luminance degradation occurs in a region A that is a boundary (also referred to an edge) between an upper portion of the task bar 31 and the window and a region B that is a boundary between an icon 32 displayed on the task bar 31 and a peripheral portion thereof.

In view of the above-mentioned problem, the laptop PC 1 according to this embodiment has a burn-in preventing function of reducing a difference in luminance degradation between a fixed image and its peripheral region. The burn-in preventing function extracts the color of an adjacent pixel that is a pixel adjacent to a fixed image and displays the fixed image with a mask (hereinafter referred to as an “overlay window”) of a color based on the extracted adjacent color. In other words, the display color of a fixed image is displayed on the touch panel display 7 in such a manner that the display color is a color based on a display color of a portion adjacent to the fixed image.

In the following description, the task bar 31 is an example of a fixed image. A color based on an adjacent color is, for example, the same color as the adjacent color, a color similar to the adjacent color, and a color that gradually changes from the adjacent color.

FIG. 4 illustrates a state in which the overlay window 33 is overlaid on the task bar 31. The overlay window 33 has the same size (longitudinal and lateral dimensions) as that of the task bar 31. As an example, the color of the overlay window 33 is translucent, and continuously changes from the adjacent color to black with an increase of the distance from the adjacent pixel (downward in the example of FIG. 4). That is, the color of the overlay window 33 is a translucent gradient color. If adjacent colors of the task bar 31 are different in the lateral direction (direction x), the colors of the overlay window 33 in the lateral direction differ accordingly.

In this manner, in the laptop PC 1, the overlay window 33 is overlaid on the fixed image (task bar 31) so that the fixed image can be displayed in a color that gradually changes from a display color of a portion adjacent to the fixed image within a predetermined range with an increase of the distance from the portion adjacent to the fixed image. The predetermined range refers to the entire range of the task bar 31 in the longitudinal direction in the example of FIG. 4 where the fixed image is the task bar 31. The present invention, however, is not limited to this range, and the predetermined range may be a part of the range from the top of the task bar 31 so that the other lower part of the range may be in a color (e.g., black) that does not change. In the example of FIG. 4, the color is a gradient color that changes from the adjacent color (the display color of the portion adjacent to the fixed image) to black. The final color of the change, however, is not limited to black, and may be another color.

When the overlay window 33 is overlaid on the task bar 31, the color of an edge of the task bar 31 becomes similar to the color of an adjacent pixel, and thus, a difference in luminance degradation between the region where task bar 31 is displayed and a peripheral region thereof is reduced. In the example of FIG. 4, the color gradation of the task bar 31 toward black is provided from the top to the bottom so that luminance of the entire task bar 31 decreases and luminance degradation is suppressed.

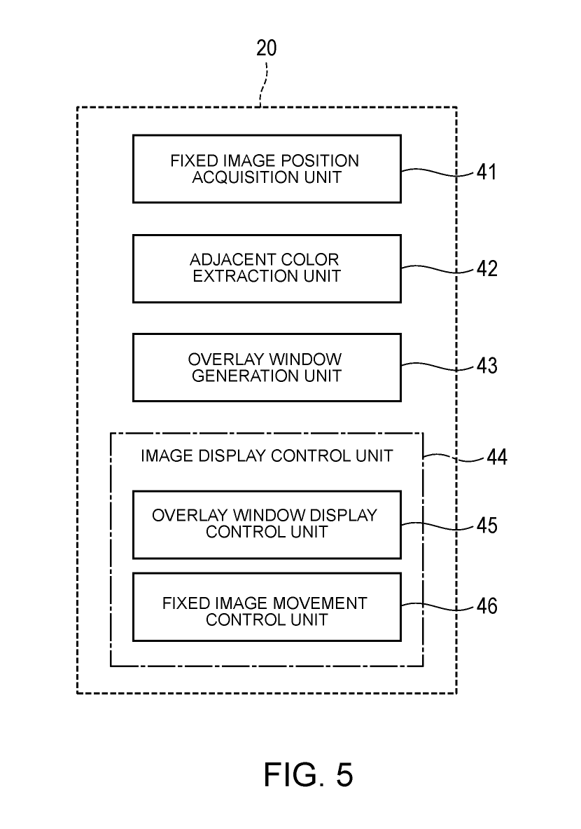

FIG. 5 is a functional block diagram of the modules within the CPU 20 for implementing a burn-in prevention function. The CPU 20 includes a fixed image position acquisition unit 41, an adjacent color extraction unit 42, an overlay window generation unit 43, and an image display control unit 44. The components of the CPU 20 are implemented by a computer program stored in the flash memory 27.

The fixed image position acquisition unit 41 acquires a position of a fixed image displayed with the position thereof on the screen of the OELD 23 being fixed.

The adjacent color extraction unit 42 extracts a color of an adjacent pixel adjacent to the fixed image as an adjacent color.

The overlay window generation unit 43 determines a color of the overlay window 33 based on the adjacent color and determines a size of the overlay window 33, thereby generating the overlay window 33.

The image display control unit 44 includes an overlay window display control unit 45 and a fixed image movement control unit 46.

The overlay window display control unit 45 displays the fixed image with the generated overlay window 33 overlaid on the fixed image. That is, as described above, the overlay window display control unit 45 displays the fixed image on the touch panel display 7 in such a manner that a display color of the fixed image is a color based on the display color of the portion adjacent to the fixed image.

The overlay window display control unit 45 displays the overlay window 33 while overlaying the overlay window 33 on a fixed image on which a cursor (mouse cursor) is not positioned, and hides the overlay window 33 on a fixed image on which the cursor is positioned. For example, when the cursor is moved to the task bar 31 on which the overlay window 33 is overlaid, the overlay window 33 is hidden so that the task bar 31 is displayed in an original color.

The fixed image movement control unit 46 repeatedly moves a fixed image by a predetermined amount (hereinafter referred to as a “minute movement”) at each time in at least one of a longitudinal direction or a lateral direction at a predetermined time interval.

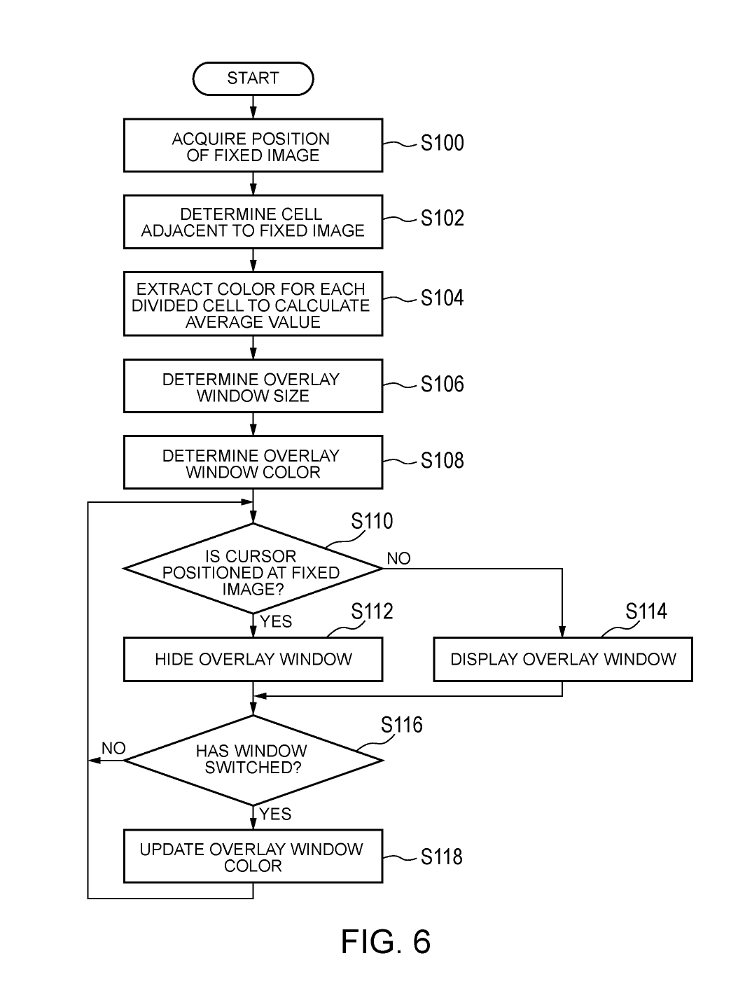

FIG. 6 is a flowchart of a method for preventing burn-in conditions on a display. In step 100, a position and a size of a fixed image (task bar 31) on the screen of the OELD 23 are acquired. In next step 102, a cell 47 adjacent to the fixed image is determined.

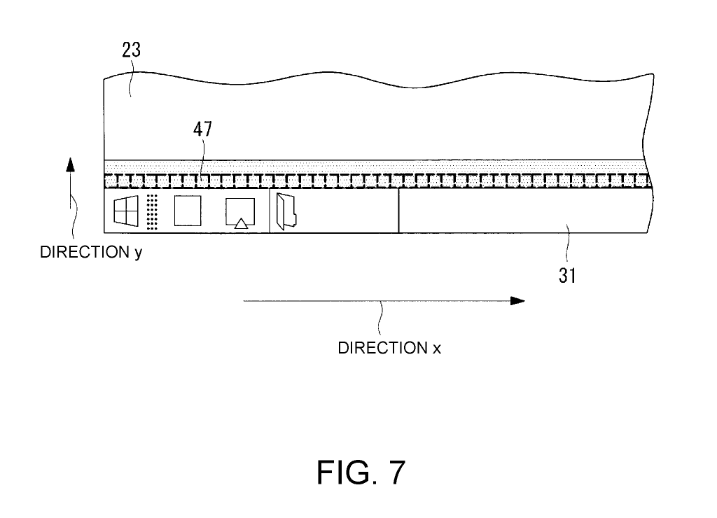

FIG. 7 illustrates an example of the cell 47. The cell 47 is a group of adjacent pixels. The size of each cell may be defined in accordance with the position on the screen, or the size and the position of a cell may be defined for each display object displayed on the screen or each regions of the same color in the display object. The task bar 31 is divided into a plurality of regions in the lateral direction (direction x), and a region having a predetermined length in a height direction (direction y) orthogonal to the lateral direction is defined as one cell 47. In this manner, the cell 47 is a region obtained by dividing a portion adjacent to the fixed image.

The lateral direction is, in other words, a direction in which a side of the task bar 31 contacting an adjacent pixel extends. In the example of FIG. 7, the task bar 31 is located at the bottom of the screen, and thus, the cell 47 is located above the task bar 31. The task bar 31 is divided into a plurality of regions in the lateral direction, and a rectangular region having a length corresponding to 10 pixels in the height direction is defined as one cell 47.

When the task bar 31 is located at the top of the screen, the cell 47 is located below the task bar 31. When the task bar 31 is located at the left end of the screen, the cell 47 is located at the right of the task bar 31. When the task bar 31 is located at the right end of the screen, the cell 47 is located at the left of the task bar 31.

In subsequent step 104, an adjacent color is extracted for each pixel in the cell 47, and an average value of the adjacent colors is calculated. The calculated color is used as an adjacent color of the cell 47. In this manner, the adjacent color of the cell 47 is determined based on the cell 47.

In next step 106, the size of the overlay window 33 is determined. The size of the overlay window 33 is equal to the size of a fixed image on which the overlay window 33 is to be overlaid. In a case where the fixed image to be processed is restrictive, the size of the overlay window 33 can be previously set. Step 106 may be performed before step 104 is performed.

In next step 108, the color of the overlay window 33 is determined. The color of the overlay window 33 is a gradient color that changes from an adjacent color corresponding to each cell 47 to black in each region in the overlay window 33 corresponding to the position of the cell 47. As an example, a linear gradation starting from an adjacent color expressed by R, G, and B and ending with black is calculated for each cell 47, thereby determining the color of the overlay window 33. Alternatively, the color of the overlay window 33 may be determined by previously storing a color chart indicating a gradation corresponding to each adjacent color in the flash memory 27 and reading out the color chart.

In this manner, the display color of the fixed image is determined for each cell 47 obtained by dividing a portion adjacent to a fixed image, and the overlay window display control unit 45 displays the fixed image of the display color determined for each region in the fixed image corresponding to the position of the cell 47.

In next step 110, it is determined whether the cursor is positioned on the fixed image or not. If yes, the process proceeds to step 112. If no, the process proceeds to step 114.

In step 112, the overlay window 33 on a fixed image on which the cursor is positioned is hidden, and the process proceeds to step 116.

In step 114, the overlay window 33 is displayed while being overlaid on the fixed image, and the process proceeds to step 116.

In step 116, it is determined whether an active window as an operation target has switched or not. If yes, the process proceeds to step 118. If no, the process returns to step 110. Switching of the window occurs when the active window is moved or erased or a new window appears. When the window switches, the adjacent color of the fixed image might switch.

In step 118, the color of the overlay window 33 is updated, and the process returns to step 110. That is, every time when the window (adjacent color) switches, a new adjacent color is extracted. If the extracted adjacent color is different from the previous adjacent color, the color of the overlay window 33 also changes. In this embodiment, the color of the overlay window 33 is updated when the active window switches, but may be updated at another timing. For example, the color of an adjacent pixel of a fixed image or the adjacent color of each cell 47 is regularly monitored, and when the color of the adjacent color or the adjacent color changes, the color of the overlay window 33 may be updated.

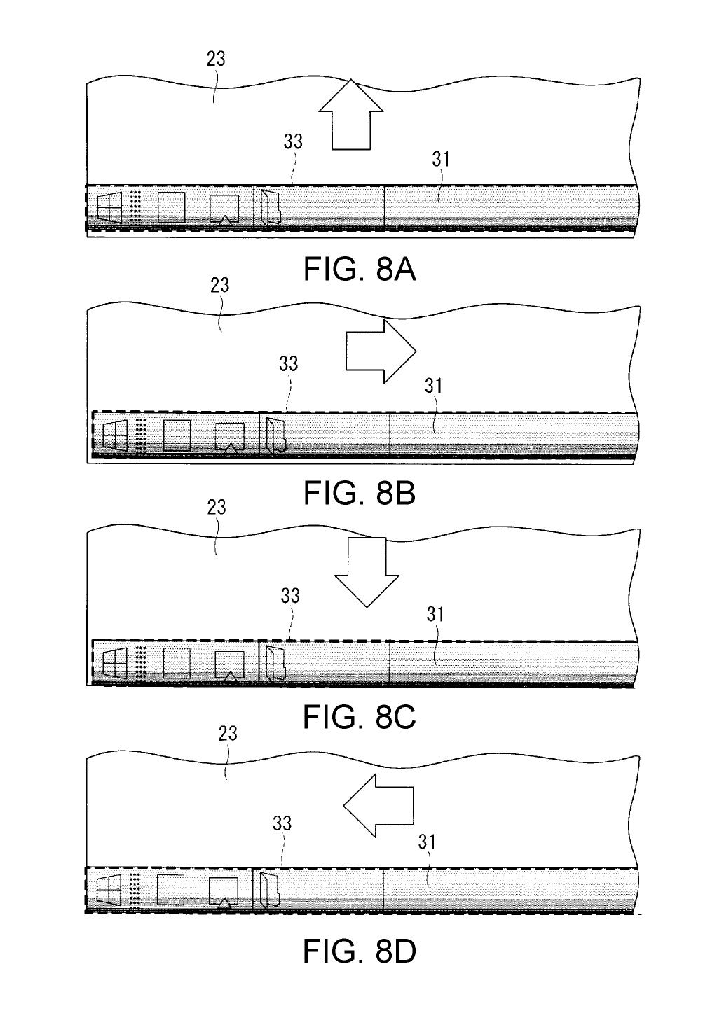

With now reference to FIGS. 8A-8D, minute movements of a fixed image are described. A minute movement is an amount of movements with which a user cannot recognize any movement of a fixed image, and is a process of continuously moving the fixed image. For example, the location at which the fixed image is displayed moves by 5 pixels at a time interval of 10 seconds.

In the examples illustrated in FIGS. 8A-8D, the task bar 31 moves upward (FIG. 8A), the task bar 31 moves to the right (FIG. 8B), the task bar 31 moves downward (FIG. 8C), and the task bar 31 moves to the left (FIG. 8D). In this manner, the task bar 31 returns to the original location. Through repetition of the movements illustrated in FIGS. 8A-8D, the task bar 31 is displayed at different locations and the location of an edge of the task bar 31 is not fixed. Thus, a difference in luminance degradation with respect to a peripheral region decreases. The overlay window 33 also moves together with the task bar 31.

As described above, the laptop PC 1 according to this embodiment extracts the position of a fixed image displayed with the position thereof on the screen of the OELD 23 being fixed, extracts the color of an adjacent pixel adjacent to the fixed image, and generates the overlay window 33 in a color based on the extracted adjacent color. The laptop PC 1 displays the overlay window 33 on the OELD 23 while overlaying the overlay window 33 on the fixed image. Thus, the laptop PC 1 can prevent burn-in of the OELD 23 that is caused by continuously displaying the same image.

As has been described, the present invention provides a method for preventing burn-in conditions on a display of an electronic device.

In the embodiment described above, the color of the overlay window 33 is a translucent graded color. The present invention, however, is not limited to this example, and the color of the overlay window 33 may be a translucent adjacent color without gradation.

In the embodiment described above, the average value of colors is calculated as an adjacent color for each cell 47. The present invention, however, is not limited to this example, and an adjacent color may be calculated by another method such as a method of calculating an average value of colors of adjacent pixels as an adjacent color without reference to the cell 47.

In the embodiment described above, the fixed image is the task bar 31. The present invention, however, is not limited to this example, and the fixed image may be an icon displayed on the desktop. In this case, the icon has adjacent pixels in four directions, that is, top, bottom, left, and right. Thus, for example, the color of the overlay window 33 is a graded color that changes from the adjacent color to black from the periphery of the icon toward the center of the icon.

In the embodiment described above, the fixed image on which the overlay window 33 is overlaid is subjected to minute movement. The present invention, however, is not limited to this example, and only the fixed image may be subjected to minute movement without overlaying the overlay window 33.

As the minute movement, the fixed image may move only in one of the longitudinal direction or the lateral direction.

A program product can be provided for preventing burn-in conditions on a display. The program product may include a computer readable storage medium that stores a processor executable code, in which the executable code may include a code used for execution of accepting a user operation.

While the invention has been particularly shown and described with reference to a preferred embodiment, it will be understood by those skilled in the art that various changes in form and detail may be made therein without departing from the spirit and scope of the invention.

What is claimed is:

1. An electronic device comprising:
a display for displaying images;
a position acquisition unit for acquiring a position of a fixed image to be displayed on said display;
a color extraction unit for extracting a color of a pixel located adjacent to said fixed image;
a mask generation unit for generating a mask having a color based on said color of said pixel located adjacent to said fixed image; and
an image display control unit for displaying said fixed image on said display with said mask overlaid on said fixed image.

2. The electronic device of claim 1, wherein said color of said mask is translucent.

3. The electronic device of claim 1, wherein said color of said mask continuously changes from said color of said pixel located adjacent to said fixed image to black with an increase of distance from said pixel located adjacent to said fixed image.

4. The electronic device of claim 1, wherein said color extraction unit uses an average value of colors of a plurality of adjacent pixels located adjacent to said fixed image.

5. The electronic device of claim 1, wherein said mask is overlaid on said fixed image when a cursor is not positioned on said fixed image, and said mask is not overlaid on said fixed image when said cursor is positioned on said fixed image.

6. The electronic device of claim 1, wherein said color of said mask is updated every time when said color of said pixel located adjacent to said fixed image switches.

7. The electronic device of claim 1, wherein said image display control unit repeatedly moves said fixed image by a predetermined movement amount at each time within at least one of a longitudinal direction or a lateral direction at a predetermined time interval.

8. A method comprising:
acquiring a position of a fixed image displayed on said display;
extracting a color of a pixel located adjacent to said fixed image;
generating a mask having a color based on said color of said pixel located adjacent to said fixed image; and
displaying said fixed image on said display with said mask overlaid on said fixed image.

9. The method of claim 8, wherein said color of said mask is translucent.

10. The method of claim 8, wherein said color of said mask continuously changes from said color of said pixel located adjacent to said fixed image to black with an increase of distance from said pixel located adjacent to said fixed image.

11. The method of claim 8, wherein said extracting further includes using an average value of colors of a plurality of adjacent pixels located adjacent to said fixed image.

12. The method of claim 8, wherein said mask is overlaid on said fixed image when a cursor is not positioned on said fixed image, and said mask is not overlaid on said fixed image when said cursor is positioned on said fixed image.

13. The method of claim 8, wherein said color of said mask is updated every time when said color of said pixel located adjacent to said fixed image switches.

14. The method of claim 8, wherein said displaying further includes repeatedly moving said fixed image by a predetermined movement amount at each time within at least one of a longitudinal direction or a lateral direction at a predetermined time interval.

15. An electronic device comprising:
a display for displaying images;
a position acquisition unit for acquiring a position of a fixed image displayed on said display; and
an image display control unit for repeatedly moving said fixed image by a predetermined movement amount in at least one of a longitudinal direction or a lateral direction at a predetermined time interval.
